(19) United States
(12) Patent Application Publication
(10) Pub. No.: US 2019/0299326 A1
(43) Pub. Date: Oct. 3, 2019

(54) Gas Lift Mandrel Manufacture with Solid-State Joining Process

(71) Applicant: Weatherford Technology Holdings, LLC, Houston, TX (US)

(72) Inventors: Robert P. Badrak, Sugar Land, TX (US); Brian M. Sternaman, Lafayette, LA (US)

(21) Appl. No.: 15/936,837

(22) Filed: Mar. 27, 2018

(51) Int. Cl. B23K 20/12; E21B 43/12; E21B 23/03

(52) U.S. Cl. CPC B23K 20/129; B23K 2203/08; E21B 23/03; E21B 43/123

(57) ABSTRACT

A method is disclosed of manufacturing a side pocket mandrel for use with a gas lift valve downhole on a tubing string. A plurality of separate components of the mandrel are manufactured. A face on at least one end of each of the separate components is configured for solid-state joining with a face on another of the separate components. Joints are then formed between the separate components by moving the face of at least one of the separate components in a solid state joining process relative to the face of at least one other of the separate components. For example, linear friction, rotary friction, or spin friction welding can be used by moving one of the faces against another. Also, an induction heater can preheat the ends to a suitable temperature to reduce the need for friction heating.

### BACKGROUND OF THE DISCLOSURE

Various downhole tools composed of low alloy steel, stainless steel, or nickel base alloy require welding of the tool components together. As one example, a gas lift mandrel typically includes a tubular housing that couples to production tubing. The mandrel can be constructed of various joints of housing components. For example, a side pocket mandrel has a tubular mandrel with a side pocket formed therein, and operators use gas lift valves in the side pockets of the mandrels to lift produced fluids in the well to the surface. Ideally, the gas lift valves allow gas from the tubing annulus to enter the tubing through the valve, but prevent flow from the tubing to the annulus.

A typical gas lift completion 10 illustrated in FIG. 1 has a wellhead 12 atop a casing 14 that passes through a formation. Tubing 20 positioned in the casing 14 has a number of side pocket mandrels 30 and a production packer 22. To conduct a gas lift operation, operators install gas lift valves 40 by slickline into the side pocket mandrels 30. One example of a gas lift valve is the McMurry-Macco® gas lift valve available from Weatherford—the Assignee of the present disclosure. (McMURRY-MACCO is a registered trademark of Weatherford/Lamb, Inc.)

With the valves 40 installed, compressed gas G from the wellhead 12 is injected into the annulus 16 between the production tubing 20 and the casing 14. In the side pocket mandrels 30, the gas lift valves 40 then act as one-way valves by allowing gas flow from the annulus 16 to the tubing string 20 and preventing gas flow from the tubing 20 to the annulus 16. Downhole, the production packer 22 forces produced fluid entering casing perforations 15 from the formation to travel up through the tubing 20. Additionally, the packer 22 keeps the gas flow in the annulus 16 from entering the tubing 20.

The injected gas G passes down the annulus 16 until it reaches the side pocket mandrels 30. Entering the mandrel's ports 35, the gas G must first pass through the gas lift valve 40 before it can pass into the tubing string 20. Once in the tubing 20, the gas G can then rise to the surface, lifting produced fluid in the tubing 20 in the process.

Some typical examples of side pocket mandrels 30 are shown in more detail in FIGS. 2A-2B. In particular, FIG. 2A illustrates a side pocket mandrel 30A according to the prior art. This mandrel 30 is similar to a Double-Valved external (DVX) gas-lift mandrel, such as disclosed in U.S. Pat. No. 7,228,909. The pocket component 36 has a side pocket 40 in an offset bulge from the mandrel's main passage 31. This pocket 40 holds the gas lift valve (not shown). The pocket's upper end has a seating profile 43 for engaging a locking mechanism of the gas lift valve, while the pocket's other end has an opening 44 to the mandrel's main passage 31.

Lower ports 46 in the mandrel's pocket 40 communicate with the surrounding annulus (not shown) and allow for fluid communication during gas lift operations. These ports 46 can communicate along the side passages 47 on either side of the pocket 40. When these passages 47 reach a seating area 49 of the pocket 42, these passages 47 communicate with the pocket 42 via transverse ports 48. In this way, fluid entering the ports 46 can flow along the side passage 47 to the transverse ports 48 and into the seating area 49 of the pocket 42 where portion of the gas lift valve (not shown) positions.

For this mandrel 30A, several mandrel components (including ends 32a-b, intermediate tubulars 34a-b, and pocket component 36) are connected by conventional welds 50. As can be seen, each of the mandrel components (ends 32a-b, intermediate tubulars 34a-b, and pocket component 36) have a number of unique internal features for forming the bulge from the side pocket 40, for directing a gas lift valve to seat in the pocket 40, and for communicating the mandrel's main passage 31 with the wellbore annulus. Accordingly, each of these mandrel components (ends 32a-b, intermediate tubulars 34a-b, and pocket component 36) are separately manufactured and then connected together by hand-welding in a manufacturing process to produce the gas lift mandrel 30A.

To function properly, the gas lift mandrel 30A must be able to run in hole as an integral component connected to other tubulars of a production string. Additionally, the gas lift mandrel 30A must have the various internal features properly arranged and aligned so that a gas lift valve can be seated, removed, etc. from the mandrel 30A while downhole. For these reasons, the welds 50 between the mandrel components (32a-b, 34a-b, 36) need to meet specific requirements for strength, precision, and the like.

The mandrel components (32a-b, 34a-b, 36) are typical composed of a suitable of low alloy steel, stainless steel, or nickel base alloy for use downhole, such as 718-nickel base alloy, etc. The hand-welding of the joints 50 of the stainless steel components offers some challenges. In particular, welders may find it difficult to weld the 718-nickel base alloy materials with repeatable and acceptable results. The arc-welding is typically performed by hand, which can introduce defects in the weld. Additionally, the arc-welding requires a large amount of filler metal to be used in multiple passes over the joints 50. Therefore, the welding typically needs to be stopped many times to prevent a build-up of heat in the component so the component's material does not exceed a set temperature. This requirement can also produce variations in the resulting weld of the joints 50.

Should a weld not be acceptable, the welders need to rework the weld by cutting the welded joint 50, machining the surfaces, and then re-welding the joint 50 again with arc-welding. This can be time consuming and can undermine the quality of the weld produced.

As opposed to welding, conventional threading has been used for connecting components of a gas lift mandrel together. For example, FIG. 2B illustrates a side pocket mandrel 30B according to the prior art having mandrel components connected by conventional threaded connections 60. Here, the mandrel 30B is shown having end 32a-b threaded with threaded connections 60 to a pocket component 36 having the side pocket 60. In some implementations, use of threaded connections 60 for the mandrel components may not be suitable.

The subject matter of the present disclosure is directed to overcoming, or at least reducing the effects of, one or more of the problems set forth above.

### SUMMARY OF THE DISCLOSURE

According to the present disclosure, a method is disclosed of manufacturing a side pocket mandrel for use with a gas lift valve downhole on a tubing string, and a side packet mandrel manufactured according to the method is disclosed.

A plurality of separate components of the mandrel are manufactured. A face on at least one end of each of the separate components is configured. At least one joint is then formed between the separate components by moving the face of at least one of the separate components in a solid state joining process relative to the face of at least one other of the separate components.

In general, each of the separate components is composed of a metallic material, such as 718 nickel base alloy. The separate components can comprises at least two end components and a pocket component, where the pocket component has an internal pocket for the gas lift valve.

A number of solid state joining process can be used, including those selected from the group consisting of an inertia welding process, a friction welding process, a linear friction welding process, a rotary friction welding process, and a spinduction welding process.

To configure the face on the at least one end of each of the separate components, a separate material can be disposed on the face of the at least one end of at least one of the separate components. For example, the separate material can be an insert or a foil disposed on the face, and the separate material can be composed of a different metallic material than that used for the separate components.

To configure the face on the at least one end of each of the separate components, the faces on the ends of the separate components can be configured as being flat and parallel relative to one another.

To form the at least one joint between the separate components, the faces are moved together with a pressing force while rotating or oscillating one of the faces relative to the other. Subsequently, tension is pulled across the at least one joint between the separate components after forming a solid state weld therebetween.

To form the at least one joint between the separate components, one of the separate components having a non-cylindrical outer surface can be supported with a holder providing a cylindrical outer surface for rotating or oscillating thereabout.

To form the at least joint between the separate components, one of the separate components having a rotational axis eccentric to a central axis of the face on the one separate component can be counterbalanced by using counterweight making the rotation axis concentric to the central axis.

To form the at least joint between the separate components, the at least one joint can be consecutively formed between the separate components from a first end of the side pocket mandrel to a second opposite end of the side pocket mandrel.

The foregoing summary is not intended to summarize each potential embodiment or every aspect of the present disclosure.

### BRIEF DESCRIPTION OF THE DRAWINGS

FIG. 1 illustrates a typical gas lift completion.

FIG. 2A illustrates a side pocket mandrel according to the prior art having mandrel components connected by conventional welds.

FIG. 2B illustrates a side pocket mandrel according to the prior art having mandrel components connected by conventional threads.

FIGS. 3A-3B illustrate a perspective view and a cross-sectional view of a side pocket mandrel according to the present disclosure having mandrel components connected by a solid-state joining process.

FIG. 4 diagrammatically illustrates a joint formed by a solid-state joining process between mandrel components.

FIGS. 5A-5D illustrate various end faces for mandrel components to be joined together by a solid-state joining process.

FIGS. 6A-6C illustrate more end faces for mandrel components to be joined together by a solid-state joining process.

FIGS. 7A-7C illustrate various modifications of end faces for mandrel components to be joined together by a solid-state joining process.

FIG. 8 schematically illustrates some elements of a mechanism for performing solid-state joining between mandrel components.

FIG. 9A illustrates an example of side pocket features added to a mandrel element with an additive manufacturing process of the present disclosure.

FIG. 9B illustrates an example of a side pock element can be manufactured separately from a mandrel element according to the present disclosure.

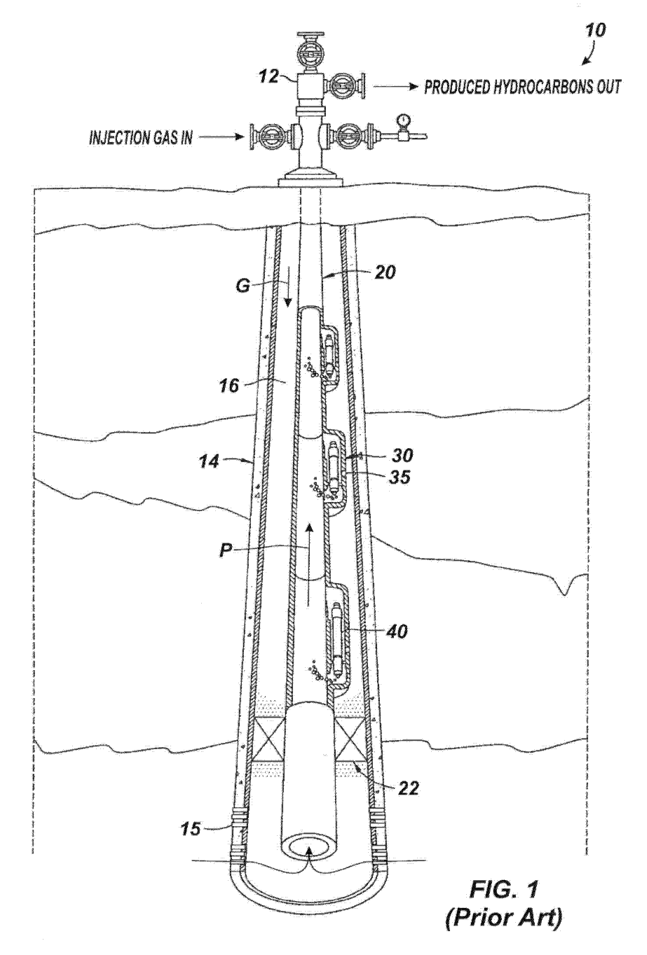

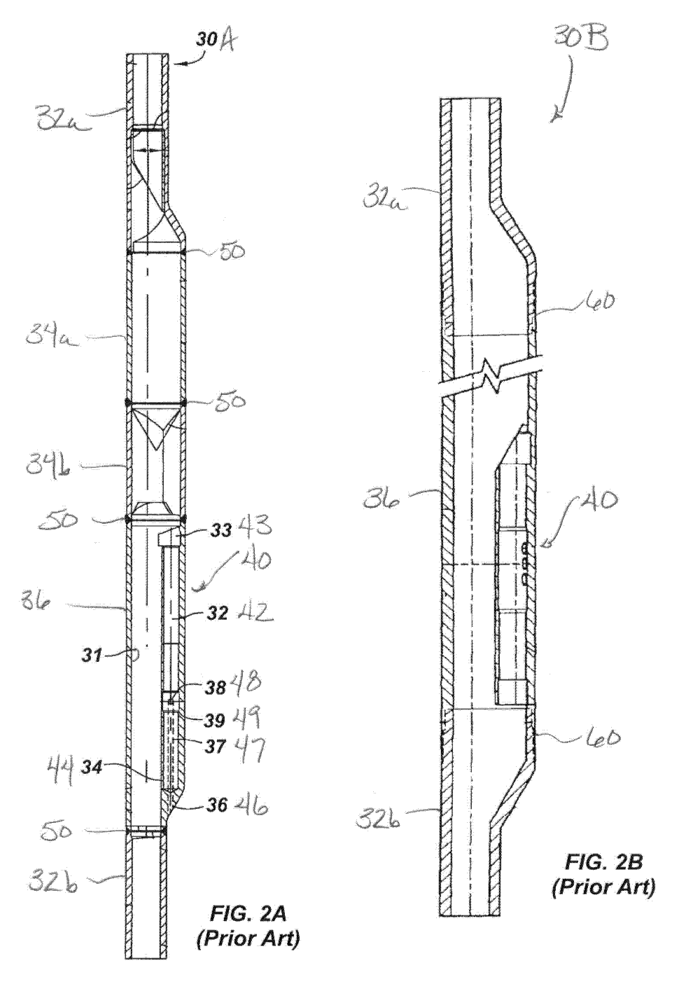

### DETAILED DESCRIPTION OF THE DISCLOSURE

According to the present disclosure, a solid-state joining process joins joints of components together. The solid-state joining process can include a linear friction welding process, a rotary friction welding process, or a spinduction metal joining process. The components can be composed of any suitable metallic material (e.g., low alloy steel, stainless steel, or nickel base alloy) for a gas lift mandrel or other downhole tool for use in a wellbore.

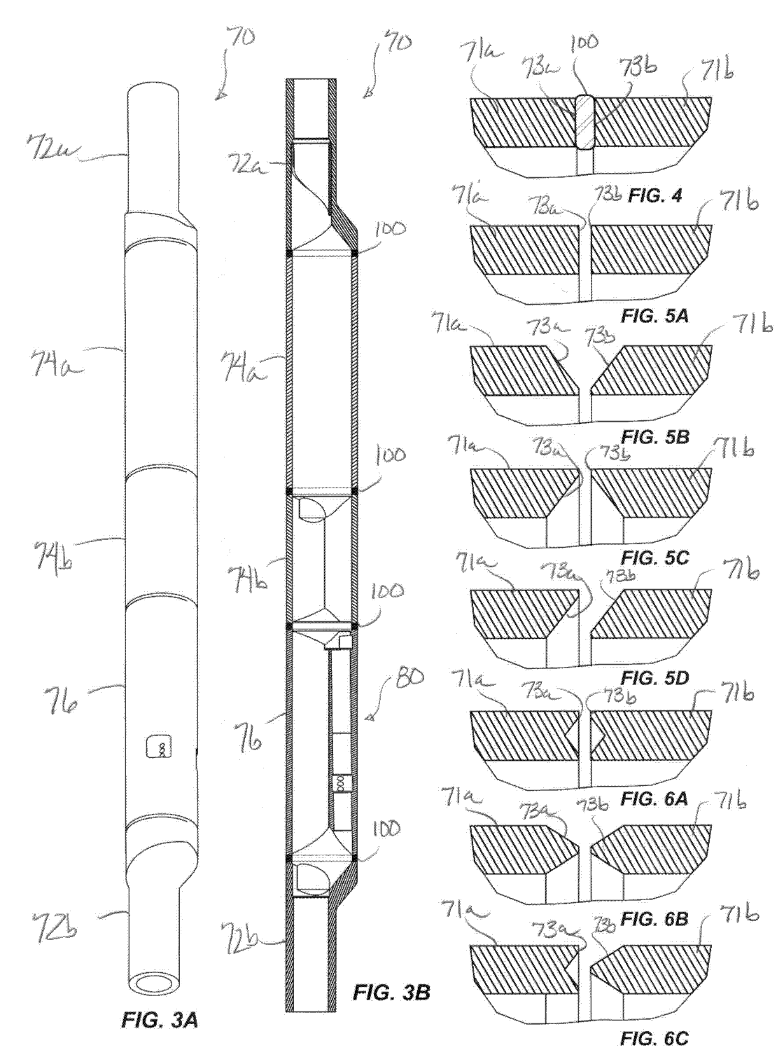

FIGS. 3A-3B illustrate a perspective view and a cross-sectional view of a side pocket mandrel 70 according to the present disclosure. The mandrel 70 has several mandrel components, including ends 72a-b, intermediate tubulars 74a-b, and pocket component 76. Each of the mandrel components (72a-b, 74a-b, and 76) have a number of unique internal features for forming the bulge from a side pocket 80, for directing a gas lift valve (not shown) to seat in the pocket 80, and for communicating the mandrel's main passage with a wellbore annulus (not shown). Accordingly, each of these mandrel components (72a-b, 74a-b, 76) are separately manufactured and then connected together with solid-state joining in a manufacturing process to produce the gas lift mandrel 70.

Rather than being connected by conventional welds or threaded connections, the mandrel components (72a-b, 74a-b, 76) are connected together by joints 100 formed by a solid-state joining process.

To function properly, the gas lift mandrel 70 must be able to run in hole as an integral component connected to other tubulars of a production string. Additionally, the gas lift mandrel 70 must have the various internal features properly arranged and aligned so that a gas lift valve can be seated, removed, etc. from the mandrel 70 while downhole. For these reasons, the joints 100 between the mandrel components (72a-b, 74a-b, 76) need to meet specific requirements for strength, precision, and the like. The joints 100 formed by a solid-state joining process for the mandrel 700 help meet these various needs.

FIG. 4 diagrammatically illustrates a joint 100 formed by a solid-state joining process between abutting mandrel components 71a-b. As will be appreciated, these mandrel components 71a-b can be cylindrical and have edges 73a-b connected together by the sold-state joint 100. In general, the joint 100 can be formed with the ends of each part joined at their flat parallel faces with equal wall thickness, although the wall thickness does not need to be consistent around the circumference of the joint 100. The joint 100 can be cylindrical or not. The strength and integrity of the joint 100 across one component 71a-b to the other should be at least as good as found with a conventionally welded joint between components.

Due to the particular metallic material used for the mandrel components 71a-b, the abutting edges 73a-b can have a number of profiles or faces relative to one another to facilities the solid-state joining process to produce a suitable joint 100 between the edges 73a-b that meets the stated requirements.

For example, FIGS. 5A-5D illustrate various end faces 73a-b for mandrel components 71a-b to be joined together by a solid-state joining process. In FIG. 5A, the end faces 73a-b are rectilinear or squared off against one another. In FIGS. 5B-5C, the end faces 73a-b are oppositely angled from one another, and the end faces 73a-b in FIG. 5D are angled complementary to one another.

FIGS. 6A-6C illustrate more end faces 73a-b for mandrel components 71a-b to be joined together by a solid-state joining process. In FIG. 6A, the end faces 73a-b have opposing slots, channels, dimples, or the like formed therein, while the end faces 73a-b in FIG. 6B have opposing extensions, rims, or the like formed toward one another. FIG. 6C shows a combination of such an extension and a slot on the faces 73a-b.

Although the end faces 73a-b in FIGS. 5A through 6C are shown with linear surfaces and sharp edges, the end faces 73a-b can includes surfaces and edges that are rounded, curved, or otherwise modified.

In the arrangements of FIGS. 5A through 6C, the mandrel component 71a-b to be joined may be composed of the same material, such as 718-nickel base alloy. Accordingly, the end faces 73a-b to be joined with the solid-state joining process may likewise be composed of the same material. Other modifications are possible.

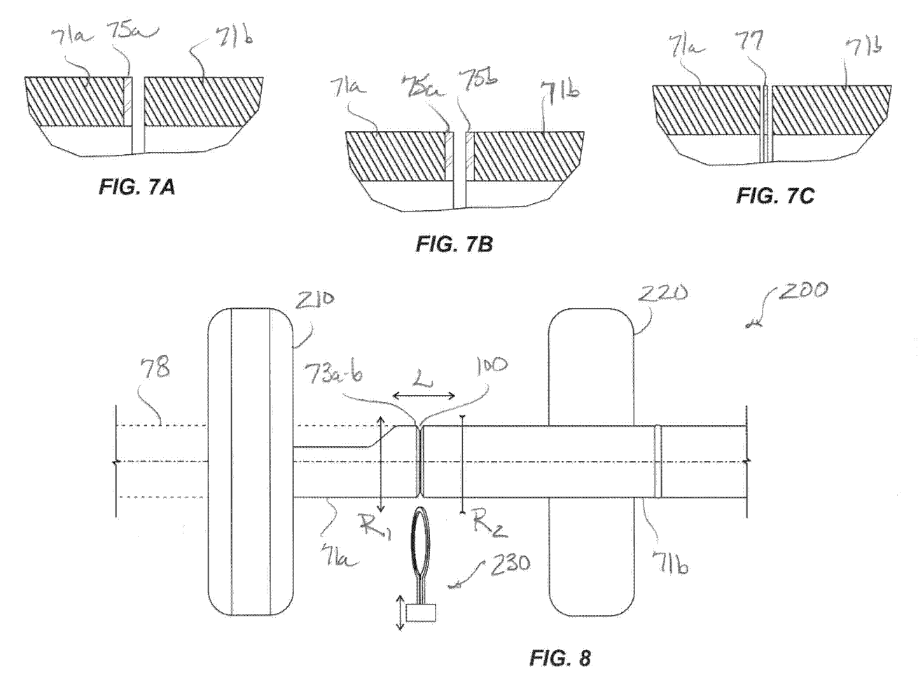

For example, FIGS. 7A-7C illustrate various modifications of end faces 73a-b for mandrel components 71a-b to be joined together by a solid-state joining process. In FIG. 7A, one of the end faces 73a can include an additional material 75a disposed thereon. This material 75a can be embedded, brazed, infused, welded, plated, or otherwise affixed to or added to the end face 73a. As an alternative, both end faces 73a-b can be modified with materials 75a-b, which may be the same or different from one another.

The type, depth, thickness, and other characteristics of the material 75a-b can be selected for the implementation. In one particular embodiment, the materials 75a-b can be inserts or foils. The additional material can be composed of the same or different material from one another and from the components 71a-b.

Rather than having affixed material as in FIGS. 7A-7B, a separate ring or piece of material 77 as in FIG. 7C can be used between the faces 73a-b to be jointed. This separate material 77 can be composed with similar material, thickness, and other characteristics discussed previously and may be placed or held between the end faces 73a-b during the solid-state joining process.

Finally, the solid-state joining process according to the present disclosure to produce the joints 100 between the mandrel components can include a linear friction welding process, a rotary friction welding process, a spinduction metal joining process, or other such process. For purposes of discussion, FIG. 8 schematically illustrates some elements of a mechanism 200 for performing the solid-state joining between mandrel components 71a-b according to the present disclosure.

As already noted, welding is a major limitation in manufacturing downhole tools, such as side pocket mandrels. The solid-state joining process implemented with the mechanism 200 can reduce welding times from hours to minutes and can improve quality.

Although shown simplified here, the mechanism 200 may include a number of other necessary elements, such as a power source, a source of shielding gas, motors, gearing, clamps, bearings, and the like. In general and depending on the solid-state joining process, the mechanism 200 can have a first element or drive 210 to move (rotate, oscillate, and/or slide) one component (e.g., 71a). The drive 210 can include one or more of spindle chuck, flywheel, motor, direct drive, and other necessary components. The mechanism 200 can have a second element 220 for the other component (e.g., 71b). This second element 220 can be a fixture, chuck, or the like for holding the component 71b stationary and applying a pressing force, or this second element 220 can also be a drive for moving (rotate, oscillate, and/or slide) the component 71b. A movable induction coil 230 may also be provided to produce heat in some joining processes.

The solid-state joining process does not use filler metals and is controlled in the mechanism 200. This prevents variables that can produce defects found in the traditional hand-welding performed by a welder. Some of the joining processes may tend to produce excess flash material on the outside and inside surface of the joint. Once the joint is finished, however, this flash material can be removed manually using a machining or grinding process.

The linear friction welding process rubs the faces 73a-b of the mandrel components 71a-b to be joined together in an oscillating manner while being pressed together in direction L. Typically, one component (e.g., 71b) is held stationary while the other component (71a) is oscillated at high frequency about rotational direction R1. Heat generated by the friction heats the metal materials to a temperature at which the faces 73a-b can join together. Joining is accomplished in the final stage by applying force or pressure to the faces resulting in an upset. Once the oscillating friction is stopped, the components are forced together resulting in an upset and then 71a-b cooled to form a butt-joint weld for the joint 100. The area of the joint 100 effected by heat can be relatively narrow, especially compared to conventional arc-welding. Any excess flash material formed inside and outside of the joint 100 can then be manually removed if necessary.

The rotary friction welding or spinduction welding process is similar to the linear friction welding process, but is well suited for joining the cylindrical mandrel components 71a-b. Rather than oscillating one component, one component (e.g., 71a) is spun at high speed for the rotary or inertia friction processes about rotational direction R1 and pressed in direction L against the other component 71b, which may be held stationary. The faces 71a-b heat from the resulting friction to a temperature for joining together. The rotation is stopped or may be stopped by the upset forging action, and the two components 71a-b are allowed to cool while held pressed together to produce the joint 100.

The spinduction joining process uses slight rotational movement of the two components 71a-b to be joined, such as about rotational directions R1, R2. Heat generated from an induction coil 230 is first applied to the faces 73a-b of the components 71a-b. The coil 230 quickly heats the faces 73a-b to a working temperature, which replaces the need to generate the heat from friction by kinetic energy. The coil 230 is moved away, and the heated faces 73a-b are brought together with a force in direction L, while one of the components 71a-b is rotated or oscillated. The solid-state weld is formed. The mechanism 200 may then pull the components 71a-b apart in direction L in slight tension at the joint 100. This can reduce the size of any bead forming on the inside and outside surfaces of the joint 100.

Because some of the components 71a-b of the mandrel 70 may be spun, oscillated or rotated in the joining process and because these components 71a-b may not be strictly cylindrical or may not be rotationally balanced, the mechanism 200 can use counterbalancing, holders, and other features to facilitate concentric spinning, oscillating or rotation of the cylindrical face 73 of the component 71 about a rotational axis A. For example, the pocket component 76 of the mandrel 70 as in FIGS. 3A-3B is formed with the offset bulge for the pocket 80 and includes the features of the inner pocket 80 and the like. Accordingly, the pocket component 76 may preferably be held stationary in the joining process while other, more cylindrical components are spun, oscillated, or rotated.

In any event, given the particular components 72a-b, 74a-b, and 76 of the mandrel 70 and how they need to be connected, it is possible that an unbalanced component or combination of components may need to be spun, oscillated, or rotated. For example, an end 72a as in FIGS. 3A-3B may need to be spun, oscillated or rotated to form its joint 100 to the intermediate component 74a, which may already be connected by its joint 100 to the other intermediate component 74b in turn already connected by its joint 100 to the pocket component 76. Counterbalances, fixtures, holders, centralizing elements, and other features 78 can be used with the drive 210 of the mechanism 200 so the concentric faces 73a-b can mate for the desired joint.

Joining the components of the mandrel together can be performed in stages in which certain components will be joined to one another first before being joined to another component. Using this technique, components in the mandrel assembly can be joined together in any order. However, joining may occur starting at one end, i.e., joining of the upper swage to the body, then body to the tool guard, then tool guard to the pocket, then pocket to the lower swage.

In one manufacturing process, for example, the components of the mandrel 70 may be joined in the following stages: (A) the end component 72b can be the movable element joined (by oscillation, rotation, etc.) to one end of the stationary pocket component 76; (B) the intermediate component 74b can be the movable element joined to the other end of the stationary pocket component 76 already connected to the end component 72b; (C) the intermediate component 74a can be the movable element joined to the other end of the stationary intermediate component 74b already connected to the components 76 and 72b; and (D) the end component 72a can be the movable element joined to one end of the stationary intermediate component 74a already connected to the component 74b, 76, and 72b.

Various variable for rotational speeds, pressing force, heat, and the like may be involved in joining the mandrel components together. These variables are generally dictated by the material properties and contact areas involved in the components to be joint. The heat resulting from friction or induction should raise the temperature of the mating faces to a forging or upsetting temperature. For example, a suitable target temperature could be 2400-F, although the exact target temperature would vary with the process and material involved.

The pocket component 76 and other separate components of the side pocket mandrel 70 can be manufactured using conventional techniques. For example, the components of the side pocket mandrel 70 can be fabricated from castings, from forgings, or from machining tube or bar stock. As an alternative, additive manufacturing can be used according to the present disclosure to manufacture the mandrel 70 or at least a portion thereof, such as features of the pocket component 76.

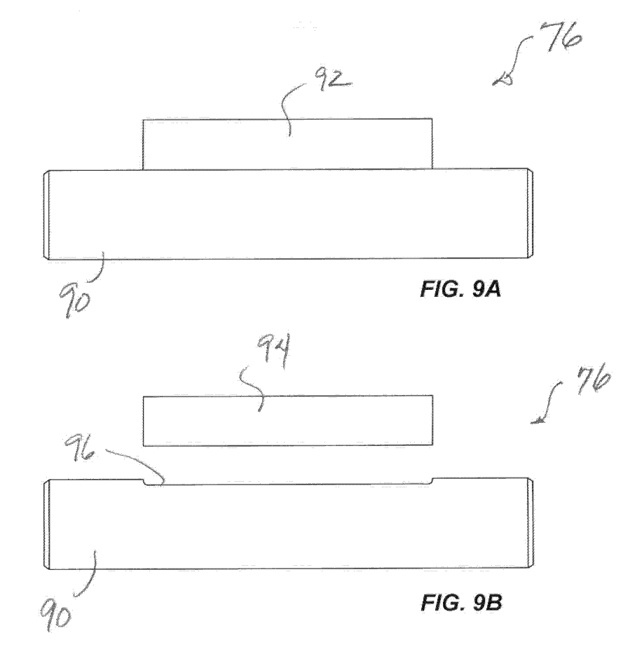

As shown in FIG. 9A, for example, an additive manufacturing process can build or print valve/pocket features 92 on a mandrel element 90 to produce the pocket component 76, and the element 90 with the built pocket features 92 can then be joined to other components using a solid state joining process as disclosed herein. For example, the element 90 may start with a honed tubular structure having holes, slots, and the like formed through the tubular wall where necessary. The features 92 can then be built-up on the tubular where needed.

Still further as shown in FIG. 9B, side pocket features for the pocket component 76 can be manufactured separately as a side pocket element 94 using a conventional process or an additive manufacturing process that builds or prints valve/pocket features for the side pocket. The side pocket element 94 can then be joined to a mandrel element 90 having an opening 96 for the side pocket using a solid state joining process, such as linear friction welding.

The additive manufacturing process can use plating or other technique. For example, a metal powder additive machining process can be performed and can use either a laser beam or an electron beam as a powder melting source to densify/consolidate the powder metal into structures of the pocket features 92. In this way, the process uses a form of plating operation to build the features as opposed building the features with the consolidation from applied heat, although heat may be applied as a secondary operation if desired. An articulating anode can deposit discrete layers of plated metal, and the composition of each layer can be controlled to produce different properties at different locations within the structure being built up. Alternatively, the metal of the features 92 can be built-up layer by layer by electroplating and controlling the location of the plating through activation/deactivation by polymers on the surface.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

What is claimed is:

1. A method of manufacturing a side pocket mandrel for use with a gas lift valve downhole on a tubing string, the method comprising:
manufacturing a plurality of separate components of the mandrel;
configuring a face on at least one end of each of the separate components; and
forming at least one joint between the separate components by moving the face of at least one of the separate components in a solid state joining process relative to the face of at least one other of the separate components.

2. The method of claim 1, wherein each of the separate components is composed of a metallic material.

3. The method of claim 2, wherein the metallic material comprises 718 nickel base alloy.

4. The method of claim 1, wherein the separate components comprises at least two end components and a pocket component, the pocket component having an internal pocket for the gas lift valve.

5. The method of claim 1, wherein the solid state joining process is selected from the group consisting of an inertia welding process, a friction welding process, a linear friction welding process, a rotary friction welding process, and a spinduction welding process.

6. The method of claim 1, wherein configuring the face on the at least one end of each of the separate components comprises disposing a separate material on the face of the at least one end of at least one of the separate components.

7. The method of claim 6, wherein disposing the separate material on the face comprises disposing the separate material as an insert or a foil on the face.

8. The method of claim 6, wherein the separate material disposed on the face comprises a first metallic material different from a second metallic material of the separate components.

9. The method of claim 1, wherein configuring the face on the at least one end of each of the separate components comprises configuring the faces on the ends of the separate components as being flat and parallel relative to one another.

10. The method of claim 1, wherein forming the at least one joint between the separate components by moving the face of at least one of the separate components in the solid state joining process relative to the face of at least one other of the separate components comprises moving the faces together with a pressing force while rotating or oscillating one of the faces relative to the other; and subsequently pulling tension across the at least one joint between the separate components after forming a solid state weld therebetween.

11. The method of claim 1, wherein forming the at least one joint between the separate components by moving the face of the at least one of the separate components in the solid state joining process relative to the face of the at least one other of the separate components comprises supporting one of the separate components having a non-cylindrical outer surface with a holder providing a cylindrical outer surface for rotating or oscillating thereabout.

12. The method of claim 1, wherein forming the at least joint between the separate components by moving the face of the at least one of the separate components in the solid state joining process relative to the face of the at least one other of the separate components comprises counterbalancing one of the separate components having a rotational axis eccentric to a central axis of the face on the one separate component by using counterweight making the rotation axis concentric to the central axis.

13. The method of claim 1, wherein forming the at least joint between the separate components comprises consecutively forming the at least one joint between the separate components from a first end of the side pocket mandrel to a second opposite end of the side pocket mandrel.

14. The method of claim 1, wherein manufacturing the plurality of separate components of the mandrel comprises fabricating at least a portion of at least one of the separate components using an additive manufacturing process.

15. The method of claim 1, wherein manufacturing the plurality of separate components of the mandrel comprises fabricating one or more of the separate components by castings the one or more of the separate components, forging the one or more of the separate components, or machining the one or more of the separate components from stock.

16. A side packet mandrel manufactured according to the method of claim 1.
